(19) United States
(12) Patent Application Publication
(10) Pub. No.: US 2006/0164365 A1
(43) Pub. Date: Jul. 27, 2006

(54) OVERDRIVE DEVICE AND METHOD THEREOF

(76) Inventors: Chung-Hsun Huang, Tainan County (TW); Yu-Chu Yang, Tainan County (TW); Fung-Jane Chang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 10/905,869

(22) Filed: Jan. 25, 2005

(51) Int. Cl. G09G 3/36

(52) U.S. Cl. 345/98

(57) ABSTRACT

An overdrive device for driving a display panel includes a comparison circuit, a multiplexer, and an overdrive module. The comparison circuit receives pixel values of display cells of the display panel in a previous frame carried on a first decompressed data signal and in a current frame carried on a second decompressed data signal, and determines whether the brightness/color of each target display cell is static to assert or de-assert a selection signal. The multiplexer outputs an output signal to output at least a reference pixel value for the overdrive module according to the selection signal. The overdrive module receives the reference pixel value, and overdrives the target display cell according to an overdrive value corresponding to a combination of the received current and reference pixel values stored in a look-up table of the overdrive module.

### BACKGROUND OF INVENTION

1. Field of the Invention

The present invention relates to display panel driving, and more particularly, to an overdrive device and a method thereof.

2. Description of the Prior Art

FIG. 1 shows the waveforms 120 of a driving voltage applied to an LCD cell and the resulting brightness 110 thereof. The LCD cell is normally white (NW). It is noted that a response time of approximate 2To is required for the brightness of the LCD cell to reach a gray level L1 from L2 when the driving voltage is abruptly pulled up from V1 to V2. This response time results from rearrangement of the LC molecules.

Different technologies are developed to shorten the response time of the LCD cells since it is a key performance of a superior LCD panel. One of these technologies is overdrive. FIG. 2 shows the waveforms 140 of another driving voltage, which is also referred to as an overdriving voltage, applied to the LCD cell and the resulting brightness 130 thereof. It is noted that a response time of only To is required for the brightness of the LCD cell to reach the level L1 from L2 when the driving voltage is overly pulled up to V2′ in an initial phase and then back to V2.

Although the overdrive shortens the response time, it may cause a side effect such as amplification of noise.

### SUMMARY OF INVENTION

It is an objective of the present invention to provide an overdrive device and a method thereof.

The present invention provides an overdrive device for driving a display panel. According to an embodiment, the overdrive device comprises: a compression circuit for receiving and compressing a source video signal carrying pixel values for each display cell of the display panel to generate a compressed data signal; a buffer coupled to the compression circuit for receiving the compressed data signal to temporally store at least the compressed data of the pixel values in a current frame period and generating a buffer data signal to output the stored data during a next frame period, wherein the current frame period is a period of a current frame, and the next frame period is a period of the next frame; a first decompression circuit coupled to the buffer for receiving the buffer data signal and decompressing the data carried thereon to generate a first decompressed data signal; a second decompression circuit coupled to the compression circuit for receiving the compressed data signal and decompressing the data carried thereon to generate a second decompressed data signal; a comparison circuit coupled to the first and second decompression circuits for receiving the pixel values of the display cells in the previous frame carried on the first decompressed data signal and in the current frame carried on the second decompressed data signal, respectively, and determining whether the brightness/color of each target display cell is static to assert or de-assert a selection signal; a multiplexer coupled to the first decompression circuit and the comparison circuit for outputting an output signal to output at least a reference pixel value according to the selection signal, wherein the reference pixel value is either the current pixel value for the target display cell carried on the source video signal or the previous pixel value for the target display cell carried on the first decompressed data signal, and the previous and current pixel values correspond to the previous and current frames, respectively; and an overdrive module coupled to the multiplexer for receiving the reference pixel value on the output signal and the current pixel value for the target display cell on the source video signal, and overdriving the target display cell according to an overdrive value corresponding to a combination of the received current and reference pixel values stored in a look-up table of the overdrive module.

While providing the overdrive device mentioned above, the present invention further provides an overdrive method for driving a display panel. According to an embodiment, the overdrive method comprises: receiving and compressing a source video signal carrying pixel values for each display cell of the display panel to generate a compressed data signal; receiving the compressed data signal to temporally store at least the compressed data of the pixel values in a current frame period and generating a buffer data signal to output the stored data during a next frame period, wherein the current frame period is a period of a current frame, and the next frame period is a period of the next frame; receiving the buffer data signal and decompressing the data carried thereon to generate a first decompressed data signal; receiving the compressed data signal and decompressing the data carried thereon to generate a second decompressed data signal; receiving the pixel values of the display cells in the previous frame carried on the first decompressed data signal and in the current frame carried on the second decompressed data signal, respectively, and determining whether the brightness/color of each target display cell is static to assert or de-assert a selection signal; outputting an output signal to output at least a reference pixel value according to the selection signal, wherein the reference pixel value is either the current pixel value for the target display cell carried on the source video signal or the previous pixel value for the target display cell carried on the first decompressed data signal, and the previous and current pixel values correspond to the previous and current frames, respectively; and receiving the reference pixel value on the output signal and the current pixel value for the target display cell on the source video signal, and overdriving the target display cell according to an overdrive value corresponding to a combination of the received current and reference pixel values stored in a look-up table of the overdrive module.

According to an embodiment, the present invention further provides a method for driving a display panel comprising the steps of: asserting or de-asserting a selection signal according to differences respectively between a current and previous pixel value of a target display cell, and a current and previous pixel value of a neighboring display cell; selecting one of the current and previous pixel value of the target display cell as a reference pixel value according to the selection signal; and overdriving the target display cell according to the current pixel value thereof and the reference pixel value.

According to an embodiment, the present invention further provides a method for driving a display panel comprising the steps of: compressing a previous and current frame; temporally storing the compressed previous frame; decompressing the compressed and temporally stored previous frame to generate previous pixel values of at least a target and neighboring display cells; decompressing the compressed current frame to generate current pixel values of at least the target and neighboring display cells; asserting or de-asserting a selection signal according to differences respectively between the current and previous pixel value of the target display cell, and the current and previous pixel value of the neighboring display cell; selecting one of the current and previous pixel value of the target display cell as a reference pixel value according to the selection signal; and overdriving the target display cell according to the current pixel value thereof and the reference pixel value.

According to an embodiment, the present invention further provides an overdrive device for driving a display panel, comprising: a comparison circuit asserting or de-asserting a selection signal according to differences respectively between a current and previous pixel value of a target display cell, and a current and previous pixel value of a neighboring display cell; a multiplexer selecting one of the current and previous pixel value of the target display cell as a reference pixel value according to the selection signal; and an overdrive module overdriving the target display cell according to the current pixel value thereof and the reference pixel value.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating the waveforms of a driving voltage applied to an LCD cell and the resulting brightness thereof according to the prior art.

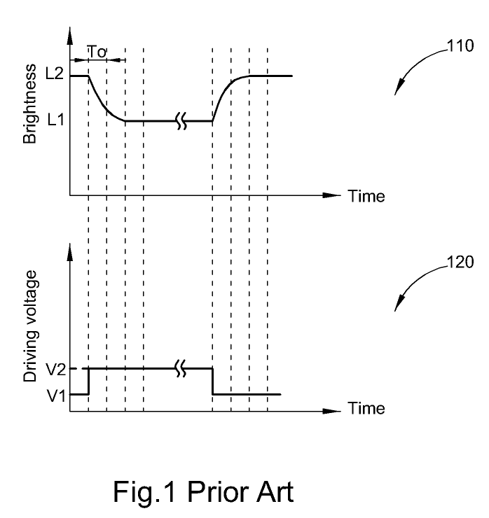

FIG. 2 is a diagram illustrating the waveforms of another driving voltage applied to the LCD cell and the resulting brightness thereof according to the prior art.

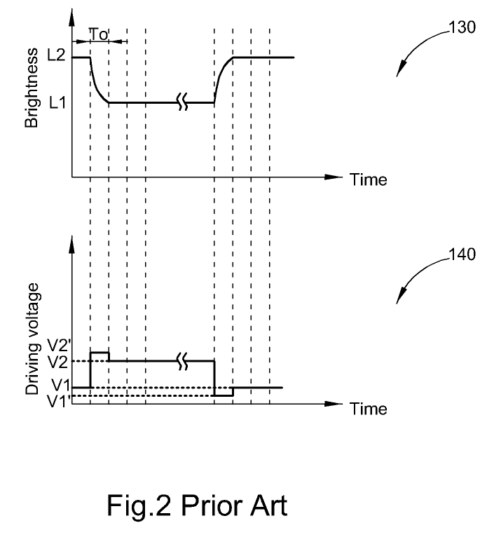

FIG. 3 is a diagram of an overdrive device for a display panel according to one embodiment of the present invention.

FIG. 4 is a flowchart of a method for driving the display panel according to one embodiment of the present invention.

FIG. 5 is a diagram of a comparison circuit according to another embodiment of the present invention.

FIG. 6 is a diagram of a comparison circuit according to another embodiment of the present invention.

### DETAILED DESCRIPTION

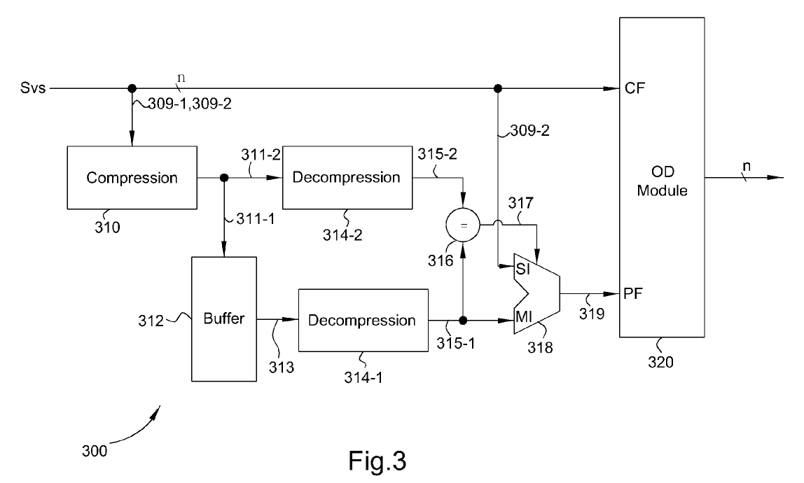

FIG. 3 is a diagram of an overdrive device for a display panel according to one embodiment of the invention. The display panel may be a liquid crystal display (LCD) panel. The overdrive device 300 includes a compression circuit 310, a frame buffer 312, two decompression circuits 314-1 and 314-2, a comparison circuit 316, a multiplexer 318, and an overdrive module 320, which is also referred to as the OD module.

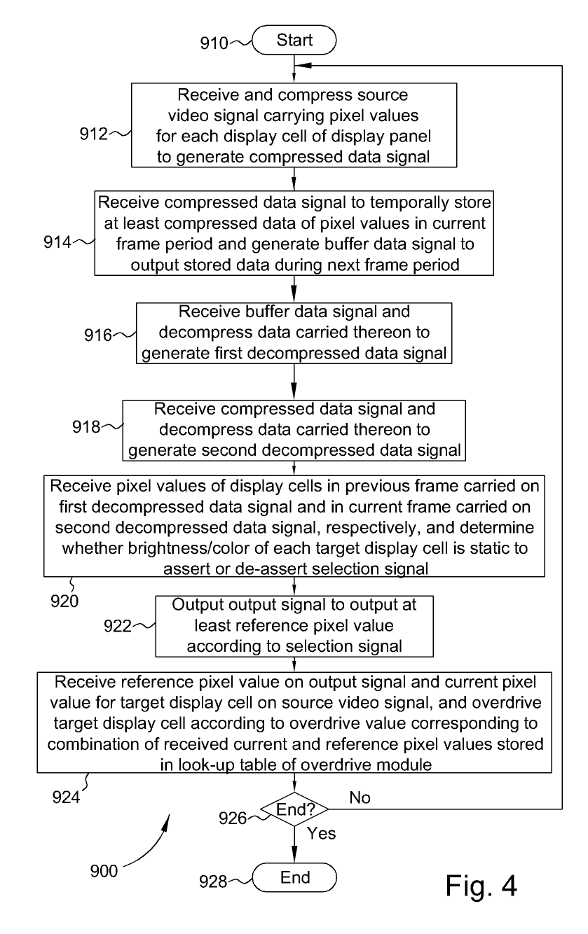

FIG. 4 is a flowchart of a method for driving the display panel using the overdrive device shown in FIG. 3 according to one embodiment of the invention.

In step 912, the compression circuit 310 receives and compresses a source video signal 309 carrying pixel values for each display cell of the display panel to generate a compressed data signal 311.

In Step 914, the frame buffer 312 receives the compressed data signal 311 to temporally store at least the compressed data of the pixel values in the current frame period (a period of a current frame) and generates the buffer data signal 313 to output the stored data during the next frame period (a period of the next frame).

In Step 916, the decompression circuit 314-1 receives the buffer data signal 313 and decompresses the data carried thereon to generate a decompressed data signal 315-1 while the decompression circuit 314-2 receives the compressed data signal 311 and decompresses the data carried thereon to generate decompressed data signal 315-2. It is noted that since the frame buffer 312 temporally stores the received data for one frame period, the decompressed data signals 315-1 and 315-2 carries the pixel values for each display cell in a previous and current frame, respectively.

In Step 918, the comparison circuit 316 receives the pixel values of the display cells in the previous frame carried on the decompressed data signal 315-1 and in the current frame carried on the decompressed data signal 315-2, respectively, and determines whether the brightness/color of each target display cell is static. The procedure goes to step 920 if it is static; otherwise, the procedure goes to step 922.

In step 920, a selection signal 317 is de-asserted by the comparison circuit 316 so that the multiplexer 318 outputs an output signal 319 to output as a reference pixel value for the overdrive module 320 the current pixel value for the target display cell carried on the source video signal 309.

In step 922, the selection signal 317 is asserted by the comparison circuit 316 so that the multiplexer 318 outputs the output signal 319 to output as the reference pixel value for the overdrive module 320 the previous pixel value (the pixel value in the previous frame) for the target display cell carried on the decompressed data signal 315-1.

In step 924, the overdrive module 320 receives the reference pixel value on the output signal 319 and the current pixel value for the target display cell on the source video signal 309. An overdrive value for each possible combination of the current and reference pixel values is stored in a look-up table. The overdrive module 320 overdrives the target display cell according to the overdrive value corresponding to the combination of the received current and reference pixel values in the look-up table.

In the previously described embodiment, the comparison circuit 316 is an equality check circuit whereby the selection signal 31 7 is asserted if the previous and current pixel values (the pixel values in the previous and current frames, respectively) for the target display cell are the same.

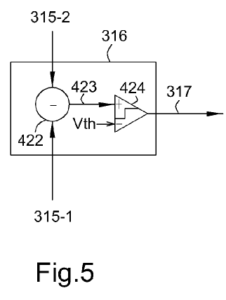

In a second embodiment as shown in FIG. 5, the comparison circuit 316 may include a subtraction circuit 422 and a comparator 424. The subtraction circuit 422 receives the previous and current pixel values for the target display cell respectively on the decompressed data signals 315-1 and 315-2, and generates an intermediate signal 423 to output a difference between the received previous and current pixel values. The comparator 424 compares the difference with a threshold represented by the voltage Vth. The comparator 424 asserts the selection signal 317 if the difference is larger than the threshold, and de-asserts the selection signal 317 if the difference smaller than the threshold. The difference smaller than the threshold is considered as noise.

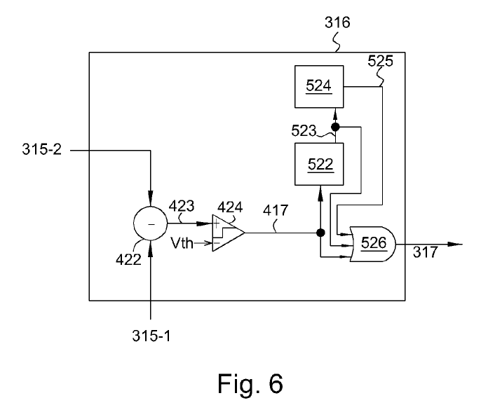

In a third embodiment as shown in FIG. 6, the comparison circuit 316 may further include two shift registers 522 and 524, and an OR gate 526. Thus, the comparison results from the comparator 424 for the target and two adjacent display cells are input to the OR gate 526. It is noted that the comparison results 417, 523 and 525 are all active-low signals. Those skilled in the art will appreciate that the OR gate 526 can be replaced with an AND gate if the comparison results 417, 523 and 525 are all active-high signals. The selection signal 317 is asserted only if all the three differences between the previous and current pixel values respectively for the target and two adjacent display cells are larger than the threshold. The target and two adjacent display cells may be in the same column or row.

The previously described embodiments have advantages of a smaller circuit area (or die size) and lower error rate in determination of static and motion image in comparison with the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An overdrive device for driving a display panel, comprising:
a compression circuit for receiving and compressing a source video signal carrying pixel values for each display cell of the display panel to generate a compressed data signal;
a buffer coupled to the compression circuit for receiving the compressed data signal to temporally store at least the compressed data of the pixel values in a current frame period and generating a buffer data signal to output the stored data during a next frame period, wherein the current frame period is a period of a current frame, and the next frame period is a period of the next frame;
a first decompression circuit coupled to the buffer for receiving the buffer data signal and decompressing the data carried thereon to generate a first decompressed data signal;
a second decompression circuit coupled to the compression circuit for receiving the compressed data signal and decompressing the data carried thereon to generate a second decompressed data signal;
a comparison circuit coupled to the first and second decompression circuits for receiving the pixel values of the display cells in the previous frame carried on the first decompressed data signal and in the current frame carried on the second decompressed data signal, respectively, and determining whether the brightness/color of each target display cell is static to assert or de-assert a selection signal;
a multiplexer coupled to the first decompression circuit and the comparison circuit for outputting an output signal to output at least a reference pixel value according to the selection signal, wherein the reference pixel value is either the current pixel value for the target display cell carried on the source video signal or the previous pixel value for the target display cell carried on the first decompressed data signal, and the previous and current pixel values correspond to the previous and current frames, respectively; and
an overdrive module coupled to the multiplexer for receiving the reference pixel value on the output signal and the current pixel value for the target display cell on the source video signal, and overdriving the target display cell according to an overdrive value corresponding to a combination of the received current and reference pixel values stored in a look-up table of the overdrive module.

2. The overdrive device of claim 1, wherein the display panel is an LCD panel.

3. The overdrive device of claim 1, wherein the comparison circuit is an equality check circuit.

4. The overdrive device of claim 1, wherein the comparison circuit comprises:
a subtraction circuit for receiving the previous and current pixel values for the target display cell respectively on the first and second decompressed data signals, and generating an intermediate signal to output a difference between the received previous and current pixel values; and
a comparator coupled to the subtraction circuit for comparing the difference with a threshold to assert or de-assert the selection signal accordingly.

5. The overdrive device of claim 4, wherein the comparator asserts the selection signal if the difference is larger than the threshold, and the comparator de-asserts the selection signal if the difference smaller than the threshold.

6. The overdrive device of claim 4, wherein the comparison circuit further comprises:
a plurality of shift registers cascaded in series and coupled to the comparator; and
a logic gate coupled to the shift registers for inputting comparison results for the target and adjacent display cells, and asserting or de-asserting the selection signal according to comparison results, wherein the logic gate is an OR gate or an AND gate.

7. The overdrive device of claim 6, wherein the plurality of shift registers comprises two shift registers, and the adjacent display cells comprises two adjacent display cells.

8. The overdrive device of claim 6, wherein the adjacent display cells and the target display cell are in the same row or the same column of the display panel.

9. An overdrive method for driving a display panel, comprising:
receiving and compressing a source video signal carrying pixel values for each display cell of the display panel to generate a compressed data signal;
receiving the compressed data signal to temporally store at least the compressed data of the pixel values in a current frame period and generating a buffer data signal to output the stored data during a next frame period, wherein the current frame period is a period of a current frame, and the next frame period is a period of the next frame;
receiving the buffer data signal and decompressing the data carried thereon to generate a first decompressed data signal;
receiving the compressed data signal and decompressing the data carried thereon to generate a second decompressed data signal;
receiving the pixel values of the display cells in the previous frame carried on the first decompressed data signal and in the current frame carried on the second decompressed data signal, respectively, and determining whether the brightness/color of each target display cell is static to assert or de-assert a selection signal;
outputting an output signal to output at least a reference pixel value according to the selection signal, wherein the reference pixel value is either the current pixel value for the target display cell carried on the source video signal or the previous pixel value for the target display cell carried on the first decompressed data signal, and the previous and current pixel values correspond to the previous and current frames, respectively; and
receiving the reference pixel value on the output signal and the current pixel value for the target display cell on the source video signal, and overdriving the target display cell according to an overdrive value corresponding to a combination of the received current and reference pixel values stored in a look-up table of the overdrive module.

10. The overdrive method of claim 9, wherein the display panel is an LCD panel.

11. The overdrive method of claim 9, further comprising:
receiving the previous and current pixel values for the target display cell respectively on the first and second decompressed data signals, and generating an intermediate signal to output a difference between the received previous and current pixel values; and
comparing the difference with a threshold to assert or de-assert the selection signal accordingly.

12. The overdrive method of claim 11, further comprising:
asserting the selection signal if the difference is larger than the threshold; and
de-asserting the selection signal if the difference smaller than the threshold.

13. The overdrive method of claim 11, further comprising:
inputting comparison results for the target and adjacent display cells, and asserting or de-asserting the selection signal according to comparison results.

14. The overdrive method of claim 13, wherein the adjacent display cells comprises two adjacent display cells.

15. The overdrive method of claim 13, wherein the adjacent display cells and the target display cell are in the same row or the same column of the display panel.

16. A method for driving a display panel comprising the steps of:
asserting or de-asserting a selection signal according to differences respectively between a current and previous pixel value of a target display cell, and a current and previous pixel value of a neighboring display cell;
selecting one of the current and previous pixel value of the target display cell as a reference pixel value according to the selection signal; and
overdriving the target display cell according to the current pixel value thereof and the reference pixel value.

17. The method as claimed in claim 16, wherein the display panel is an LCD panel.

18. The method as claimed in claim 16, wherein the current and previous pixel values of the target/neighboring display cell are pixel values for the target/neighboring display cell in a current and previous frame, respectively.

19. The method as claimed in claim 18, wherein a value for each possible combination of the current and reference pixel value is stored in a look-up table, and the method further comprises the step of identifying the value corresponding to the combination of the current and reference pixel value in the look-up table so that the target display cell is overdriven according to the identified value.

20. The method as claimed in claim 19, wherein the neighboring display cell and the target display cell are located at the same row or the same column of the display panel.

21. The method as claimed in claim 19, wherein the selection signal is asserted when the differences between the current and previous pixel value of the target display cell, and the current and previous pixel value of the neighboring display cell are both larger than a threshold.

22. The method as claimed in claim 21, wherein the previous pixel value of the target display cell is selected as the reference pixel value when the selection signal is asserted.

23. The method as claimed in claim 16 further comprising the steps of:
compressing a previous frame;
temporally storing the compressed previous frame; and
decompressing the compressed and temporally stored previous frame to generate the previous pixel values of the target and neighboring display cells.

24. The method as claimed in claim 16 further comprising the steps of:
compressing a current frame; and
decompressing the compressed current frame to generate the current pixel values of the target and neighboring display cells.

25. A method for driving a display panel comprising the steps of:
compressing a previous and current frame;
temporally storing the compressed previous frame;
decompressing the compressed and temporally stored previous frame to generate previous pixel values of at least a target and neighboring display cells;
decompressing the compressed current frame to generate current pixel values of at least the target and neighboring display cells;
asserting or de-asserting a selection signal according to differences respectively between the current and previous pixel value of the target display cell, and the current and previous pixel value of the neighboring display cell;
selecting one of the current and previous pixel value of the target display cell as a reference pixel value according to the selection signal; and
overdriving the target display cell according to the current pixel value thereof and the reference pixel value.

26. An overdrive device for driving a display panel, comprising:
a comparison circuit asserting or de-asserting a selection signal according to differences respectively between a current and previous pixel value of a target display cell, and a current and previous pixel value of a neighboring display cell;
a multiplexer selecting one of the current and previous pixel value of the target display cell as a reference pixel value according to the selection signal; and
an overdrive module overdriving the target display cell according to the current pixel value thereof and the reference pixel value.

27. The overdrive device as claimed in claim 26, wherein the display panel is an LCD panel.

28. The overdrive device as claimed in claim 26, wherein the current and previous pixel values of the target/neighboring display cell are pixel values for the target/neighboring display cell in a current and last frame, respectively.

29. The overdrive device as claimed in claim 28, wherein a look-up table stores a value for each possible combination of the current and reference pixel value, and the overdrive module further identifies the value corresponding to the combination of the current and reference value in the look-up table, and overdrives the target display cell according to the identified value.

30. The overdrive device as claimed in claim 29, wherein the neighboring display cell and the target display cell are located at the same row or the same column of the display panel.

31. The overdrive device as claimed in claim 29, wherein the comparison circuit asserts the selection signal when the differences between the current and previous pixel values of the target display cell, and the current and previous pixel values of the neighboring display cell are both larger than a threshold.

32. The overdrive device as claimed in claim 31, wherein the multiplexer selects the previous pixel value of the target display cell as the reference pixel value when the selection signal is asserted.

33. The overdrive device as claimed in claim 26 further comprising:
a compression circuit compressing a previous frame;
a buffer temporally storing the compressed previous frame; and
a decompression circuit decompressing the compressed previous frame output from the buffer to generate the previous pixel values of the target and neighboring display cells.

34. The overdrive device as claimed in claim 26 further comprising:
a compression circuit compressing a current frame; and
a decompression circuit decompressing the compressed current frame to generate the current pixel values of the target and neighboring display cells.
